(19) United States
(12) Patent Application Publication
(10) Pub. No.: US 2014/0260322 A1
(43) Pub. Date: Sep. 18, 2014

(54) SUPPORT MECHANISM FOR HEAVY STRUCTURE

(71) Applicant: KAWASAKI JUKOGYO KABUSHIKI KAISHA, Kobe-shi (JP)

(72) Inventors: Katsunori TANAKA, Kobe-shi (JP); Shinya OHARA, Kakogawa-shi (JP)

(73) Assignee: KAWASAKI JUKOGYO KABUSHIKI KAISHA, Kobe-shi (JP)

(21) Appl. No.: 14/287,765

(22) Filed: May 27, 2014

Related U.S. Application Data
(63) Continuation of application No. PCT/JP2012/080045, filed on Nov. 20, 2012.

(30) Foreign Application Priority Data
Nov. 28, 2011 (JP) 2011-258828

(51) Int. Cl. F02C 7/20; F16M 13/02

(52) U.S. Cl. CPC F02C 7/20; F16M 13/02
USPC 60/797; 248/331

(57) ABSTRACT

To provide a support mechanism for a heavy structure, capable of accommodating thermal deformation of component parts of a device operated under high temperature condition, a support mechanism for supporting the heavy structure by suspending includes a fast pulley fixed to an inner wall of a package that accommodates the heavy structure which is an object being supported, a movable pulley to function cooperatively with the fast pulley, a rope-like connecting member having one end connected with the structure and movably wound on the fast pulley and the movable pulley, a counterweight unit coupled to the other end of the connecting member and including a counterweight having adjustable weight to utilize the weight of the counterweight to support the heavy structure, and a suspending device in the counterweight unit to suspend and position the heavy structure at a position upwardly relative to a normal support position.

### CROSS REFERENCE TO THE RELATED APPLICATION

This application is a continuation application, under 35 U.S.C. §111(a), of international application No. PCT/JP2012/080045, filed Nov. 20, 2012, which claims priority to Japanese patent application No. 2011-258828, filed Nov. 28, 2011, the disclosure of which are incorporated by reference in their entirety into this application.

### BACKGROUND OF THE INVENTION

1. Field of the Invention

The present invention relates to a mechanism for supporting a device including a component part of a kind having a heavy weight, and used under a high temperature condition, such as a gas turbine engine.

2. Description of Related Art

In recent years, a lean fuel intake gas turbine, in which a combustible component contained in a VAM (ventilation air methane) and/or a CMM (coal mine methane) both generated from a coal mine is utilized as a fuel, has been suggested in, for example, the patent document 1 listed below. The lean fuel intake gas turbine makes use of some bulky component elements, such as a catalytic combustor or high pressure piping, having large weight ratio relative to a gas turbine main body.

### Patent Document

Patent Document 1: JP Laid-open Patent Publication No. 2010-019247

### SUMMARY OF THE INVENTION

In order to install those component elements in a saved space or a limited available space, it is desirable that heavy structures such as, for example, a catalytic combustor, a startup combustor and some high pressure tubes be mounted on and/or above a gas turbine main body (including a compressor and a turbine). In that case, a mechanism aiding the support of the heavy structures is needed in order that the operation of the gas turbine engine will not be adversely affected by those heavy structures supported by the gas turbine main body. Also, a mechanism for supporting a device that is used under a high temperature condition such as the gas turbine engine is desired to have a configuration capable of accommodating deformation of various members brought about by the effect of heat.

In view of the foregoing, the present invention has for its object to provide a support mechanism for a heavy structure capable of accommodating the thermal deformation of component parts of a device that is operated under a high temperature condition.

In order to accomplish the foregoing object, a support mechanism in accordance with the present invention, is support mechanism for supporting a heavy structure by suspending, which includes: a fast pulley fixed to an inner wall of a package that accommodates the heavy structure which is an object being supported; a movable pulley configured to function cooperatively with the fast pulley; a rope-like connecting member having one end connected with the structure and movably wound on the fast pulley and the movable pulley; a counterweight unit coupled to the other end of the connecting member, the counterweight unit including a counterweight having weight which is adjustable and utilizing the weight of the counterweight to support the heavy structure; and a suspending device provided in the counterweight unit to suspend and position the heavy structure at a position upwardly relative to a normal support position.

According to the present invention, the heavy structure, which is a component element of a device such as a gas turbine engine, which is operated under a high temperature condition, may be supported while deformation resulting from thermal expansion is accommodated. Also, removal and re-fitting of the component elements during the maintenance service of the device may be facilitated.

In one embodiment of the present invention, the counterweight may be provided with, as the suspending device, a winding device to wind up and fix the rope-like connecting member. In this case, the winding device may be either fitted to a frame that is configured to guide the counterweight in a vertical direction or fitted to the counterweight. According to these structural features, removal and re-fitting of the component element during the maintenance service of the device may be further facilitated.

In one embodiment of the present invention, the counterweight may be provided with, as the suspending device, a weight stopper to vertically position the counterweight from below. According to this structural feature, removal and re-fitting of the component element during the maintenance service of the device may be facilitated with a simplified configuration.

A gas turbine engine in accordance with the present invention is a gas turbine engine having a portion of component elements supported by the support mechanism as described above, which includes: a compressor and a turbine juxtaposed to each other along an axial direction; a reduction gear unit mounted on a bottom wall of the package to support the compressor in a cantilevered fashion; a heat exchanger mounted on a bottom wall of the package to perform a heat exchange between an exhaust gas from the turbine and a compressed gas from the compressor; a main combustor coupled to an upper portion of the turbine; an auxiliary combustor coupled to an upper portion of a turbine exhaust tube coupling the turbine to the combustor; and a gas supply tube that couples the heat exchanger to the main combustor, in which each of the main combustor, the auxiliary combustor and the gas supply tube is supported by the support mechanism. In this case, for example, the heat exchanger may support the turbine exhaust tube and the auxiliary combustor in a cantilevered fashion. According to these structural features, the heavy structures which are not placed on a bottom wall of the package may be supported while the deformation resulting from the thermal expansion is accommodated. Accordingly, the normal operation of the gas turbine engine may be warranted for a long time and, therefore, the reliability may increases.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a perspective view showing the structure of a support mechanism in accordance with one embodiment of the present invention;

FIG. 2 is a block diagram showing a schematic structure of a gas turbine engine shown in FIG. 1;

FIG. 3 is a perspective view showing a counterweight unit used in the support mechanism shown in FIG. 1;

FIG. 4 is a front elevational view showing, on an enlarged scale, a portion of the counterweight unit shown in FIG. 3; and

FIG. 5 is a perspective view showing a modified form of the counterweight unit shown in FIG. 3.

### DESCRIPTION OF EMBODIMENTS

Hereinafter an embodiment of the present invention will be described in detail with reference to the accompanying drawings. In particular, FIG. 1 illustrates a perspective view of a support mechanism SA, designed according to one embodiment of the present invention, and a gas turbine engine GT, which is an apparatus operated under a high temperature condition, and is to be supported by such support mechanism SA. The gas turbine engine GT includes a compressor 1, a main combustor 3, a turbine 5 and a heat exchanger 7. This gas turbine engine GT as a whole is installed within a package 9. It is to be noted that, although the package 9 referred to above encloses the gas turbine engine GT in its entirety, FIG. 1 illustrates only respective portions of a bottom wall, a side wall and a top wall, with other structural elements of the package being omitted for the sake of brevity.

The gas turbine engine GT employed in the practice of the embodiment is so designed as a lean fuel intake gas turbine engine, which mixes a low calorie gas such as, for example, CMM (coal mine methane) produced in the coal mine, with an air and/or a VAM (ventilation air methane) which has been discharged from the coal mine, and suck a resultant mixture thereinto to utilize a content combustible component as a fuel. The main combustor 3 is configured as a catalytic combustor including a catalyst such as, for example, platinum and/or palladium. As the heat exchanger 7 employed in the practice of this embodiment, a heat exchanger of a crossflow type, in which a heating medium and a cooling medium flow in respective directions perpendicular to each other, may be utilized.

The structure of the gas turbine engine GT is schematically shown in FIG. 2. As the low calorie gas employed in this gas turbine engine GT, a working gas G1, which is obtained by mixing two fuel gases of different fuel concentrations, such as, for example, the VAM generated in the coal mine and the CMM which has a concentration of the combustible component (methane) higher than that of the VAM, is introduced into the gas turbine engine GT through an intake port of the compressor 1. The working gas G1 is compressed by the compressor 1 to provide a high pressure compressed gas G2 which is in turn supplied to the main combustor 3. The compressed gas G2 is burned by a catalytic reaction of the catalyst such as, for example, platinum or palladium, in the main combustor 3 and a high temperature and high pressure combustion gas G3 produced thereby is supplied to the turbine 5 to drive the turbine 5. The turbine 5 is drivingly connected with the compressor 1 and a power generator 11 through a rotary shaft 15 and, accordingly, the compressor 1 and the power generator 11 are driven by the turbine 5.

The heat exchanger 7 heats the compressed gas G2 that is to be introduced from the compressor 1 into the main combustor 3 by using a turbine exhaust gas G4 discharged from the turbine 6. The compressed gas G2 from the compressor 1 is supplied to the heat exchanger 7 through a compressed gas passage 21. Then the compressed gas G2 is, after it has been heated by the heat exchanger 7, supplied to the main combustor 3 through a high temperature compressed gas passage 25. The turbine exhaust gas G4 having flown past the main combustor 3 and then the turbine 5 is introduced into the heat exchanger 7 through a turbine exhaust gas passage 29. An exhaust gas G5 emerging outwardly from the heat exchanger 7 is, after having been silenced by a silencer (not shown), discharged to the outside. The compressed gas passage 21 and the high temperature compressed gas passage 25 are communicated with each other through a heat exchanger bypass passage 35 having an on-off valve 31 provided thereon. In order to prevent the main combustor 3 from being excessively heated which would result in a burnout, the on-off valve 31 is opened as necessary to allow the compressed gas G2 to bypass the heat exchanger 7.

The gas turbine engine GT further includes an auxiliary combustor 38 in addition to the main combustor 39. This auxiliary combustor 39 is used to warm up the heat exchanger 7 by supplying a high temperature combustion gas to the heat exchanger 7, during a period from the startup of the gas turbine engine GT and before the main combustor 3 attains a predetermined working temperature. The auxiliary combustor 39 receives a fuel (for example, the CMM in the illustrated embodiment) supplied from an exclusive fuel supply passage 41, as well as an air supplied from a starter air extraction passage 45 ramified from the compressed gas passage 21.

A specific structure of the gas turbine engine GT will now be described. As shown in FIG. 1, the compressor 1, the turbine 5 and the heat exchanger 7 are arranged in this order in a direction along a longitudinal axis C1 of the gas turbine engine GT. It is to be noted that in the description that follows, a direction perpendicular to the direction of the longitudinal axis C1 and the vertical direction may be referred to as a transverse direction T. In addition, on one side opposite to the turbine 5 in the longitudinal axis C1, a reduction gear unit 49 is disposed and coupled directly to the compressor by means of a plurality of bolts. The main combustor 3 is coupled to a top portion of the turbine 5. A turbine exhaust tube 53 forming the turbine exhaust gas passage 29 is interposed between the turbine 5 and the heat exchanger 7. The auxiliary combustor 39 is provided on an upper portion of the turbine exhaust tube 53.

The reduction gear unit 49 has a lower portion provided with a reduction gear unit support platform 57 that concurrently serves as an oil tank for the reduction gear unit 49 and also defines a placement surface for the reduction gear unit 49. On the other hand, a heat exchanger main body 7a, which has a rectangular parallelepiped shape, has a bottom portion coupled to a heat exchanger support platform 59 that defines a placement surface for the heat exchanger 7. The reduction gear unit support platform 57 and the heat exchanger support platform 59 cooperate with each other to position the gas turbine engine in the direction of the longitudinal axis C1. Also, a gas turbine main body made up of the compressor 1, the main combustor 3 and the turbine 5 supported by the reduction gear unit 49 in a cantilevered fashion, while the turbine exhaust tube 53 and the auxiliary combustor 39 are supported by the heat exchanger 7 in a cantilevered fashion.

The heat exchanger 7 of a crossflow type is arranged such that its center of gravity is located at a point substantially coinciding with the longitudinal axis C1 of the rotary shaft 15. The turbine exhaust gas G4, which serves as a heating medium, passes towards the direction of the longitudinal axis C1 within the heat exchanger 7 and, on the other hand, the compressed gas G2, which serves as a cooling medium, migrates within the heat exchanger 7 from one side (a back side of FIG. 1) to the opposite side (a fore side of FIG. 1) of such heat exchanger 7 in the transverse direction T.

A side portion 7b on an outlet side of the heat exchanger main body 7a and an upper portion of the main combustor 3 are coupled with each other by means of the high temperature compressed gas supply tube 73 that forms the high temperature compressed gas passage 25. The high temperature compressed gas supply tube 73 is so shaped as to represent an L-shaped configuration so that the high temperature compressed gas G2 (shown in FIG. 2) discharged upwardly of the vertical direction from the heat exchanger 7 may be guided into the main combustor 3. The high temperature compressed gas supply tube 73 has a portion oriented towards the main combustor 3, extending from an outlet side side portion 7b of the heat exchanger main body 7a, which is at a position away from the longitudinal axis C1, towards the main combustor 3, which is positioned on the longitudinal axis C1 in a plane view, in a fashion inclined relative to the longitudinal axis C1.

Of the various component elements of the gas turbine engine GT, a bulky structural object, which is not directly supported by a structure placed directly on the bottom wall of a package 9 and has its weight that occupies a large proportion relative to the weight of the gas turbine main body, is supported by the support mechanism SA. In the instance shown in FIG. 1, the main combustor 3, the auxiliary combustor 39 and the high pressure compressed gas supply tube 73 are supported by the support mechanism SA.

The support mechanism SA supports the heavy structure, which is an object structure to be supported and which is likely to be thermally deformed when used under a high temperature atmosphere, by suspending it through a fast pulley, fixed to an inner wall (in the instance as shown, an upper wall), and a movable pulley that is configured to function cooperatively with the fast pulley, with the utilization of the weight of a counterweight CW. More specifically, each of a wire rope 103, which is a rope-like connecting member, has one end fitted to an object structure to be supported, through a respective engagement member 105A to 105C and also has the opposite end coupled to a respective counterweight unit 109. A single fast pulley 113 and a fast pulley unit 117, which is made up of a combination of a plurality of, (for example, five, in the instance shown in FIG. 1) fast pulleys 115 arranged in an axial direction thereof, are fitted to an upper wall, which is an inner wall of the package 9. Each wire rope 103 is so provided as to extend from a counterweight unit 109 via the fast pulley 113 and the fast pulley unit 117 and further via a movable pulley unit 121, in which a plurality of (that is, the number equal to the number of the fast pulleys 115 of the associated fast pulley unit 117) movable pulleys 119 are arranged in an axial direction thereof and combined together, to a position where an object structure to be supported is installed. The wire rope 103 is wound on an outer peripheral groove of each of the fast pulleys 113 and 115 or the movable pulley 119, and the winding length may be either smaller than the circumference of the outer peripheral groove of each pulley, for example, ¼ of the circumference of the outer peripheral groove of each pulley, or longer in excess of the circumference of the outer peripheral groove of each pulley.

The engagement members 105A to 105C may be suitably selected in consideration of the weight, shape and size of the object structures to be supported. In the embodiment now under discussion, the engagement member 105A of a rectangular frame shape is used for the main combustor 3, the engagement member 105B of a crisscross shape is used for the auxiliary combustor 39, and the engagement member 105C of a hook-like shape is used for the high temperature compressed gas supply tube 73.

Hereinafter, the configuration of the counterweight unit 109 will be described in detail. As shown in FIG. 3, the counterweight unit 109 includes a counterweight CW having weight which is adjustable to support the object structure to be supported by suspending it utilizing the weight of the counterweight CW. In the instance as shown, the weight of the counterweight CW as a whole is adjusted by increasing or decreasing the number of weight elements, each of which is of a rectangular parallelepiped shape and has a predetermined weight.

As shown in FIG. 4, each of the weight elements 125 has a center portion in a horizontal direction which is formed with a throughhole 129, and a weight support rod 131, which serves as a support member capable of supporting the plurality of the weight elements 125, is inserted through this throughhole 129. For the weight support rod 131, an eye bolt having one end (an upper end) foamed with a ring-shaped head portion 131a is used, so that the other end of the wire rope 103 is coupled to the ring-shaped head portion 131 a through a connecting member 133 such as, for example, a shackle. A nut 135 is threaded to the other end (a lower end) of the weight support rod (eye bolt) 131 to support the weight element or elements 125. By changing the number of the weight elements 125 through which the weight support rod 131 is inserted, the weight required to support the object structure to be supported can be adjusted. Other than that, a counterweight CW of a different weight that is sufficient to support the object structure to be supported may be prepared beforehand.

As shown in FIG. 3, the weight element 125 has its opposite end portions in the lengthwise direction thereof, which is guided in the vertical direction by a frame 139. The frame 139 has a lower portion provided with a flat plate-shaped positioning plate 141 for regulating the downward position of the weight element 125 in the vertical direction. Positions and dimensions of those members are set or established so that during the halt of the gas turbine engine a lower end of the weight element 125 may be spaced from the positioning plate 141 a distance sufficient to accommodate the thermal deformation of the object structure to be supported.

Also, the counterweight unit 109 is provided with a suspending device for suspending and positioning the heavy structure at a position upwardly from a normal support position. In the instance as shown, as the suspending device, a winding device 143 is provided in the frame 139 at a front portion thereof for winding as necessary the wire rope 103. When the heavy structure, which is one of the component elements, is removed from the gas turbine engine GT for the purpose of maintenance and inspection service and/or replacement of component parts, the other end of the wire rope 103 is fitted to the winding device 143 instead of being coupled to the weight support rod 131. In this way, the heavy structure, which is the component element of the gas turbine engine GT, may be easily suspended.

The winding device 143 may be fitted to an upper portion of the frame 139. Also, the winding device 143 may be directly fitted to one of the weight elements 125 which is positioned uppermost of all, instead of being provided in the frame 139. In this case, in supporting the heavy structure during the operation of the gas turbine engine GT, the other end of the wire rope 103 is fastened to the weight support rod 131 through the winding device 143.

As a modified form of the suspending device provided in the counterweight unit 109, a weight stopper 147 for vertically positioning the weight element 125 from below as shown in FIG. 5 may be employed instead of the winding device 143. Specifically, a throughhole is formed at a center portion of the positioning plate 141, and the weight stopper 147, which includes a positioning nut 155 and an entirely threaded stopper member 159 having the positioning nut 155 threadingly mounted thereon, is inserted into the throughhole. By turning the positioning nut 155 on the stopper member 159 to change the relative position with the stopper member 159, the vertical position of the weight element 125 may be adjusted.

As hereinbefore described, according to the support mechanism SA designed in accordance with the embodiment, the heavy structure, which is a component element of the device (gas turbine engine GT) that is operated under a high temperature condition, may be supported while the deformation resulting from the thermal expansion is accommodated. In addition, removal and re-fitting of the component element during the maintenance service of the device may be facilitated.

Although the present invention has been fully described in connection with the embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Compressor
3 . . . Main combustor
5 . . . Turbine
7 . . . Heat exchanger
9 . . . Package
39 . . . Auxiliary combustor
49 . . . Reduction gear unit
73 . . . High temperature compressed gas supply tube
109 . . . Counterweight unit
113 . . . Fast pulley
117 . . . Fast pulley unit
119 . . . Movable pulley
121 . . . Movable pulley unit
143 . . . Winding device (Suspending device)
147 . . . Weight stopper (Suspending device)
CW . . . Counterweight
GT . . . Gas turbine engine
SA . . . Support mechanism

What is claimed is:

1. A support mechanism for supporting a heavy structure by suspending, comprising:
a fast pulley fixed to an inner wall of a package that accommodates the heavy structure which is an object being supported;
a movable pulley configured to function cooperatively with the fast pulley;
a rope-like connecting member having one end connected with the structure and movably wound on the fast pulley and the movable pulley;
a counterweight unit coupled to the other end of the connecting member, the counterweight unit including a counterweight having weight which is adjustable and utilizing the weight of the counterweight to support the heavy structure; and
a suspending device provided in the counterweight unit to suspend and position the heavy structure at a position upwardly relative to a normal support position.

2. The support mechanism for the heavy structure as claimed in claim 1, wherein the counterweight is provided with, as the suspending device, a winding device to wind up and fix the rope-like connecting member.

3. The support mechanism for the heavy structure as claimed in claim 2, wherein the winding device is fitted to a frame that is configured to guide the counterweight in a vertical direction.

4. The support mechanism for the heavy structure as claimed in claim 2, wherein the winding device is fitted to the counterweight.

5. The support mechanism for the heavy structure as claimed in claim 1, wherein the counterweight is provided with, as the suspending device, a weight stopper to vertically position the counterweight from below.

6. A gas turbine engine having a portion of component elements supported by the support mechanism as claimed in claim 1, comprising:
a compressor and a turbine juxtaposed to each other along an axial direction;
a reduction gear unit mounted on a bottom wall of the package to support the compressor in a cantilevered fashion;
a heat exchanger mounted on a bottom wall of the package to perform a heat exchange between an exhaust gas from the turbine and a compressed gas from the compressor;
a main combustor coupled to an upper portion of the turbine;
an auxiliary combustor coupled to an upper portion of a turbine exhaust tube that couples the turbine to the main combustor; and
a gas supply tube that couples the heat exchanger to the main combustor;
wherein each of the main combustor, the auxiliary combustor and the gas supply tube is supported by the support mechanism.

7. The gas turbine engine as claimed in claim 6, wherein the heat exchanger supports the turbine exhaust tube and the auxiliary combustor in a cantilevered fashion.
